(19) United States
(12) Patent Application Publication
(10) Pub. No.: US 2025/0075726 A1
(43) Pub. Date: Mar. 6, 2025

(54) Fastening Aid for Fastening Components to a Carrier Component as well as Method and Apparatus for Attaching such a Fastening Aid

(71) Applicant: Illinois Tool Works Inc., Glenview, IL (US)

(72) Inventors: Luigi MERLO, Glenview, IL (US); Martin KLUGE, Röttingen (DE); Paul RING, Burgthann (DE)

(21) Appl. No.: 18/819,972

(22) Filed: Aug. 29, 2024

(30) Foreign Application Priority Data
Aug. 30, 2023 (DE) 102023123328.9

(51) Int. Cl. F16B 21/08; F16B 11/00; F16B 21/07

(52) U.S. Cl. CPC F16B 21/088; F16B 11/006; F16B 21/071; F16B 21/084

(57) ABSTRACT

Disclosed is a fastening aid for fastening components to a carrier component, in particular a body of a motor vehicle. The fastening aid includes a plate-shaped carrier body composed of a hard component having a fastening side and an attachment side, wherein the attachment side is the side with which the fastening aid is attached to the carrier component. The fastening aid further comprises a soft component provided on the attachment side, wherein the soft component is made from an adhesive material activatable through the carrier body. A fastening element is arranged on the fastening side, which can be connected to a counter-fastening element of a component.

### RELATED APPLICATIONS

The present application claims the benefit of German Patent Application No. 10 2023 123 328.9, filed Aug. 30, 2023, titled “Ultrasonic Weldable Fasteners,” the contents of which are hereby incorporated by reference.

### BACKGROUND

Recent developments in body construction of motor vehicles provide for the manufacture of large portions of the body or the entire body as a single piece, in particular in a casting process. Such a manufacturing process is significantly easier when as few grooves, recesses, undercuts, and/or fastening points as possible are provided on the part to be produced. The casting mold can thus be configured in a much simpler manner. However, these fastening points are necessary in order to fasten components, such as plastic panels or fixings for wiring harnesses, to the body.

A closing disc for sealingly closing an opening of a carrier component, in particular on a motor vehicle, is known from the as yet unpublished German patent application DE 10 2022 120 370.0. The closing disc comprises a closing side on which an adhesive material is arranged.

### SUMMARY

The present disclosure relates generally to a fastening aid for fastening components to a carrier component, substantially as illustrated by and described in connection with at least one of the figures, as set forth more completely in the claims. The present disclosure relates generally to a fastening aid for fastening components to a carrier component, in particular a body of a motor vehicle, as well as a method and an apparatus for attaching such a fastening aid.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a perspective top view of a schematic representation of a fastening aid according to the disclosure, having a fastening element in the form of a bolt with wing elements.

FIG. 2 illustrates a side-cut schematic diagram of the fastening aid according to the disclosure, having the fastening element in the form of a bolt with wing elements.

FIG. 3 illustrates a perspective top view of a schematic representation of the fastening aid according to the disclosure, having a fastening element in the form of a pin having a catching element molded thereon.

FIG. 4 illustrates a side-cut schematic representation of the fastening aid according to the disclosure, having the fastening element in the form of a pin having a catching element molded thereon.

FIG. 5 illustrates a perspective top view of a schematic representation of the fastening aid according to the disclosure, having a fastening element in the form of a bushing having the catching elements molded thereon.

FIG. 6 illustrates a side-cut schematic representation of the fastening aid according to the disclosure, having the fastening element in the form of a bushing having catching elements molded thereon.

FIG. 7 illustrates a perspective top view of a schematic representation of a soft component of the fastening aid according to the disclosure.

FIG. 8 illustrates a side-cut schematic representation of the soft component of the fastening aid according to the disclosure.

### DETAILED DESCRIPTION

The problem addressed by the present disclosure is to make available a fastening aid for fastening components to a carrier component, in particular a body of a motor vehicle, as well as a method and an apparatus for attaching such a fastening aid, wherein the fastening aid is simply and functionally configured and is thus inexpensive to manufacture.

A further problem addressed by the present disclosure is to make available a fastening aid for fastening components to a carrier component, in particular a body of a motor vehicle, as well as a method and an apparatus for attaching such a fastening aid, wherein an attachment of the fastening aid is possible in a simple, precise, flexible, and reliable manner.

A further problem addressed by the present disclosure is to make available a fastening aid for fastening components to a carrier component, in particular a body of a motor vehicle, as well as a method and an apparatus for attaching such a fastening aid, wherein it is possible to attach a plurality of fastening aids quickly one after the other.

One or more of these problems are solved by the features of independent claims. Advantageous configurations are specified in the respective dependent subclaims.

According to the disclosure, a fastening aid is provided for fastening components to a carrier component, in particular a body of a motor vehicle. The fastening aid includes a plate-shaped carrier body composed of a hard component having a fastening side and an attachment side, wherein the attachment side is the side with which the fastening aid is attached to the carrier component. The fastening aid further comprises a soft component provided on the attachment side, wherein the soft component is made from an adhesive material activatable through the carrier body. A fastening element is arranged on the fastening side, which can be connected to a counter-fastening element of a component.

By means of the fastening aid, it is possible to fasten a component to any location on a carrier component. On the carrier component itself, no fastening means, such as undercuts or catching lugs, are necessary for the component. With the fastening aid, the fastening means is provided in the form of the fastening element on the carrier component. Thus, the carrier component can be simply configured. Any texturing previously required in order to serve as a fastening means is no longer necessary and can be omitted in the manufacture of the carrier component. This makes production much simpler and therefore less expensive. In particular, texturing such as undercuts is difficult to introduce into the carrier component during the manufacture of such a carrier component and requires additional work steps or laboriously designed tools. This is particularly true when the carrier component is a body element that is to be cast in its entirety. But not only the production of the carrier component is simplified. Planning of the carrier component prior to production can also be faster, because the design of the carrier component is less complicated.

The fastening of a component at any location on a carrier component is possible, because the fastening aid itself can be attached to any location on a carrier component. The fastening aid also does not require any fastening means on the carrier component. The fastening aid comprises the adhesive material by which it can be attached to the carrier component. The fastening aid is therefore very flexible and easy to use. Fastening means need not be introduced to the carrier component after the fact, for example through the boring of a hole. At the same time, the fastening aid can be easily attached to surfaces of difficult-to-machine materials, such as metal, by means of the adhesive material.

The activatable adhesive material is understood to mean an adhesive material that exercises its adhesive action as soon as an activation energy is introduced. The activation energy in particular ensures that the adhesive material melts and, after curing, bonds to a surface in a material-locking fashion. However, it can also be provided that the adhesive material exercises an adhesive effect without melting.

Because the soft component is made from an adhesive material that can be activated through the carrier body, the handling of the fastening aid is very simple. The fastening aid can be precisely arranged as long as the soft component is not yet activated and is precisely fastened to the intended destination if it does not have to be moved again.

For example, with known fastening aids, it is necessary to peel off a protective foil before attaching. Such fastening aids do not comprise adhesive material that can be activated through the carrier body.

Because the fastening element can be flexibly attached to a carrier component at any location, the location of the application can also be adjusted for a short time, for example to compensate for the overlap of another component. It is additionally provided that the fastening element can be designed as desired. In this way, the fastening element to be provided by means of the fastening aid can be changed in a short time frame. This can be particularly helpful in the construction of prototypes.

The carrier body can be substantially smooth in form (apart from the fastening element) and can comprise only the soft component. The term “smooth” is understood to mean that the carrier body does not have any grooves, recesses, or undercuts, in particular on the fastening side (apart from the fastening element) and the attachment side. In addition, the feature can mean that the soft component is only provided on the surface of the attachment side and that the soft component is not arranged on a radially or tangentially circumferential edge of the carrier body. This results in a very simple construction of the fastening aid.

The plate-shaped and preferably smooth carrier body can be circular disc-shaped, for example. However, the carrier body can also have any other shape, for example an oval, elliptical, or polygonal shape.

The carrier body can have a smooth fastening side (apart from the fastening element) and a likewise smooth attachment side and a smooth radially circumferential side wall, such that a surface of the carrier body is only formed from these three smooth surfaces.

Likewise, the carrier body (apart from the fastening element) can also be flat or level in shape. For example, the carrier body can have a planar fastening side (apart from the fastening element) and a planar attachment side and a planar, radially circumferential side wall.

The carrier body can be manufactured in an injection-molding process. Preferably, the carrier body and the fastening element are manufactured integrally in one piece and made of the same material, so that the carrier body can be manufactured together with the fastening element in an injection-molding process. However, it is also possible for the fastening element to be made of a different material than the carrier body and fixedly connected thereto.

A fully flat or planar surface is understood to mean that it is free of undercuts, catching means, edges, or the like. However, on the fastening side and/or the attachment side, a sprue for manufacturing the fastening aid by means of an injection-molding process as well as an opening for introducing the soft component over the hard component can be provided during manufacture by means of a 2-component injection-molding process.

The soft component can be configured such that it is not tacky or has no adhesive properties as delivered, so that no contaminants can adhere to it.

The carrier body and the fastening element can be made from PPT (polytrimethylene terephthalate) or PPA (polyphthalamide), in particular with glass fibers, and in particular from a recyclate. Polyamides and other thermoplastics that can be processed in the injection-molding method are also possible in order to form the carrier body and the fastening element.

The soft component can be made from TPE (thermoplastic elastomer) or TPS (terephthalic acid) and in each case a heat-activatable adhesive or EVA (ethylene vinyl acetate). Ethyl vinyl acetate copolymers (EVAC or also EVA) are copolymers made from ethylene and vinyl acetate.

If the fastening aid is made of a plastic, it has a high sealing capacity and highly water-repelling properties.

The fastening aid can be made from a heat-resistant material, in particular a heat-resistant plastic. The fastening aid can be made from recycled material.

The soft component is configured in terms of material and thickness to achieve a high retention force after bonding.

The soft component can be activated by one or more of the following activation methods: preferably by means of ultrasonography, by means of electromagnetic radiation, in particular infrared light, wherein the carrier body is configured to be permeable to the electromagnetic radiation and the soft component is configured to be impermeable to the electromagnetic radiation, by means of hot air, by means of induction, wherein the carrier body is configured such that a current that heats the carrier body can be induced, and/or wherein a current that heats the carrier component in a region of the fastening aid is induced, or by means of physical pressure.

The different activation methods are preferably provided such that they introduce a high energy input into the adhesive material. Thus, the adhesive material is quickly activated and the fastening aid can be quickly attached.

In the use of electromagnetic radiation as the activation method, the carrier body is made from a substantially transparent material for electromagnetic radiation. This is primarily understood to mean materials that are not electrically conductive. Thus, the electromagnetic radiation can reach the soft component nearly unhindered in order to activate it. At the same time, the soft component can be made from an electromagnetic radiation-absorbing material. Thus, the electromagnetic radiation is absorbed by the soft component and outputs energy to the soft component, thereby heating it.

If the soft component is activated by hot air, it is then expedient for the soft component to have a lower melting temperature than the hard component. Thus, the hard component does not melt upon activation of the soft component.

In the activation method by means of induction, the carrier body can be made from a material into which a current can be induced that heats the carrier body. In particular, this is at least semi-metallic material.

It is also possible for the carrier component to be made from a material such that a current can be induced into the carrier component that heats the carrier component in a region of the fastening aid. The phrase “in a region of the fastening aid” means a region of the surface of the carrier component onto which the fastening aid is to be applied while being sufficiently large (but not too large) in order to activate the soft component.

It can also be provided that both the carrier body and the carrier component are made from a material into which a current can be induced.

In the activation methods by means of ultrasound, electromagnetic radiation, hot air, and induction, it is preferably provided that the soft component is activated through the carrier body. However, it can also be provided that the soft component is activated through the carrier component insofar as the structural configuration of the carrier component allows this.

The fastening element can be configured as one of the following elements: a pin with or without a catching element molded thereon, a bushing having a blind boring, with or without an internal threading, with or without at least one catching element molded thereon, a bolt having at least one movable wing element molded thereon, which is configured to act as a barbed hook for a counter-fastening element, a bolt with or without an external threading, a hook, an eyelet, a catching lug, or an undercut.

The fastening element can be configured to form a bayonet closure together with a corresponding counter-fastening element.

The fastening element can be configured as desired. Because any one of the fastening elements can be subsequently attached to a finished carrier component by means of the fastening aid, carrier components can be produced uniformly for different applications. The fastening means required for the particular application can be provided by the varied design of fastening elements by means of the fastening aid.

A counter-fastening element to be attached to the fastening element is configured to correspond to the fastening element so that it can be fastened to the fastening element. That is to say, if the fastening element has a threading, for example, then the counter-fastening element is also configured to have a thread.

The fastening element, in a top plan view of the fastening side, can be limited to a central region of the fastening side, so that the fastening aid on the fastening side can be contacted with an activation device circumferentially at an edge region of the fastening side.

In a top plan view of the fastening side, the fastening element is preferably limited to a central region of the fastening side. This means that the fastening element has no texturing that extends beyond the central region of the fastening side, such that an activation device cannot be placed on the fastening side. The activation device is preferably a device that can be placed entirely circumferentially on the edge region of the fastening side in order to activate the soft component. In such a set-up state, the fastening element is preferably received from a cavity of the activation device so that the activation device can reach up the surface of the fastening side.

It is also possible for the activation device to not contact the surface of the fastening side circumferentially. It can be provided that individual regions of the surface remain free. Overlapping texturing elements of the fastening element can then also project into these regions without disrupting the positioning of the activation device on the surface of the fastening side.

The fastening aid can have a shape that is complementary to a surface of the carrier component.

The plate-shaped carrier body can have a curved shape or otherwise, so that it can also be placed on a non-planar surface, wherein a full surface contact is still ensured between the attachment side, in particular the adhesive material, and the surface.

The carrier body can comprise a texturing on the attachment side, wherein regions are provided at which no soft component is arranged.

The soft component can be arranged fully on the closure side. The soft component can alternatively be annular disc-shaped or circular-annular disc-shaped or arranged in any pattern on the attachment side. Here, it can be provided that the soft component covers approx. at least 10% or approx. at least 20% or approx. at least 30% or approx. at least 40% or approx. at least 50% or approx. at least 60% or approx. at least 70% or approx. at least 80% or approx. at least 90% or approx. at least 100% of a surface of the attachment side of the carrier body.

The greater the surface area the soft component covers on the attachment side of the carrier body, the higher the retention force of the fastening aid after bonding.

The soft component can be configured to terminate approximately flush with a tangential or radially circumferential side wall of the carrier body. Bars or other shapes can also be provided on the attachment side that limit the soft component, wherein the soft component also terminates here approximately flush with these shapes.

The soft component can comprise a texturing on the attachment side, wherein discharge channels are configured in the texturing which extend at least in sections approximately outwardly towards the edge of the carrier body.

By means of the discharge channels, excess air can be discharged, which in particular accumulates when the fastening aid is arranged between the soft component and the surface to be applied. This air can be forced outward by the soft component itself along the discharge channels during a melting process of the soft component. It can be advantageous when a pressure is exerted on the fastening side of the carrier body. In this way, the air is pressed out.

Melted adhesive material and/or impurities that can arise during the application process can also be removed through the discharge channels.

Preferably, the discharge channels extend substantially radially outward. For example, the texturing can be configured as a corrugated structure, a diamond structure, or a honeycomb structure, and thus a vectored structure having at least approximately radially outward extending discharge channels that can be connected to one another.

The carrier body can have a wall thickness of a max. 5 mm or max. 4 mm or max. 3 mm or max. 2 mm or max. 1 mm.

It can also be provided that the carrier body has a wall thickness of max. 0.9 mm or max. 0.8 mm or max. 0.7 mm or max. 0.6 mm or max. 0.5 mm. In order to compensate for the weakening associated with the thinner wall thickness of the carrier body, the carrier body can comprise stiffening ribs that extend radially circumferentially and are equally spaced apart from one another in the radial outward direction.

The carrier body can be circular disc-shaped and preferably has a diameter of 40 mm or 30 mm or 20 mm.

Through-holes can be provided in the carrier body, which extend from the attachment side to the fastening side and in which the soft component is arranged, in order to establish a material-locking connection between the carrier body and the soft component when the soft component is cured.

With such an arrangement, the bond between the hard component and the soft component is reinforced. This means that after activation of the soft component, it is harder to separate it from the hard component. In this way, the carrier body is prevented from being torn from the soft component by a force effect, in particular a tensile effect, on the fastening element.

It can also be provided that the fastening element comprises at least one cavity and/or at least one through-hole in which the soft component is also arranged. Thus, once the soft component is activated, the bond between the hard component and the soft component is additionally reinforced.

The through-holes can each comprise a contour, in particular widenings on the fastening side, in which the soft component is arranged in order to establish a positive-locking connection between the carrier body and the soft component when the soft component is cured.

This arrangement provides for further reinforcement of the bond between the hard component and the soft component when the soft component is activated. Thus, after activation of the soft component, an even greater force effect, in particular a tensile effect, is necessary in order to separate the carrier body from the soft component.

Furthermore, an apparatus for attaching a fastening aid as explained above to a carrier component, in particular a body of a motor vehicle, is provided. The apparatus comprises a reservoir for retaining fastening aids, in particular different types of fastening aids, having a soft component. The apparatus further comprises a traveling device in order to supply one of the fastening aids from the reservoir to the activation device. In addition, the apparatus comprises an activation device for arranging the fastening aid at a location on the carrier component to be attached and for generating ultrasonic or for generating electromagnetic waves or for generating hot air or for generating an induction voltage or for generating a physical pressure to activate the soft component and attach the fastening aid.

The reservoir can be configured as a magazine comprising a traveling cylinder, with the help of which the fastening aids can be moved into a frontmost position of the reservoir.

The activation device is configured to arrange the fastening aids at the location to be attached and then directly attach them using one of the activation methods. The activation device comprises a head element configured to receive and fix a fastening aid and simultaneously activate the soft component.

Further, the activation device comprises exchangeable components, which can be attached depending on the activation method. The components comprise the means necessary to provide the particular activation method.

The traveling device is configured to supply a fastening aid from the reservoir to the activation device. For this purpose, the traveling device can comprise a traveling cylinder, which can receive the fastening aid at the frontmost position of the reservoir and move it towards the head element of the activation device. The reservoir and the activation device are preferably arranged with respect to one another such that the frontmost position of the reservoir is arranged horizontally adjacent to the head element of the activation device. The traveling device thus only has to travel a short and straight path.

The reservoir, activation device, and traveling device are preferably coupled to one another such that they form a unit. This unit preferably comprises a movement device with which it can be moved in order to reach a different location on the carrier component. The unit can be mounted on a movable robotic arm for this purpose.

The activation device is in particular an ultrasonic welding device having a sonotrode configured to output ultrasonic waves.

The advantages described above with reference to the fastening aid apply analogously to the apparatus according to the disclosure for attaching such a fastening aid.

In addition, a method for attaching a fastening aid as discussed above to a carrier component, in particular a body of a motor vehicle, is provided, having an apparatus for attaching such a fastening aid as described above. The method comprises the following steps: retaining of fastening aids in a reservoir, providing one of the fastening aids from the reservoir for a traveling device, supplying the fastening aid to an activation device by means of the traveling device, arranging the fastening aid by means of the activation device at a location on the carrier component to be attached, and attaching the fastening aid at the location to be attached by way of an activation of a soft component of the fastening aid by means of the activation device.

With the method, fastening aids can be quickly attached one after the other in different locations.

The method provides that the soft component is preferably activated by means of ultrasound or electromagnetic radiation, in particular infrared light, or hot air or induction voltage induced into a carrier body of the fastening aid and/or into the carrier component, or physical pressure. Activation of the soft component activates an adhesive effect of the soft component, thereby creating an adhesive (material-locking) connection between the fastening aid and the carrier component.

Furthermore, the method provides that activation of the soft component occurs through the carrier body of the fastening aid. The carrier body is correspondingly transparently configured when activation by electromagnetic radiation takes place. If activation is carried out by means of an induction voltage, which is to be induced in the carrier body, then the carrier body is at least partially metallically configured so that a current can be induced.

The advantages described above with reference to the fastening aid and the apparatus for attaching such a fastening aid apply analogously to the method according to the disclosure for attaching the fastening aid having such an apparatus.

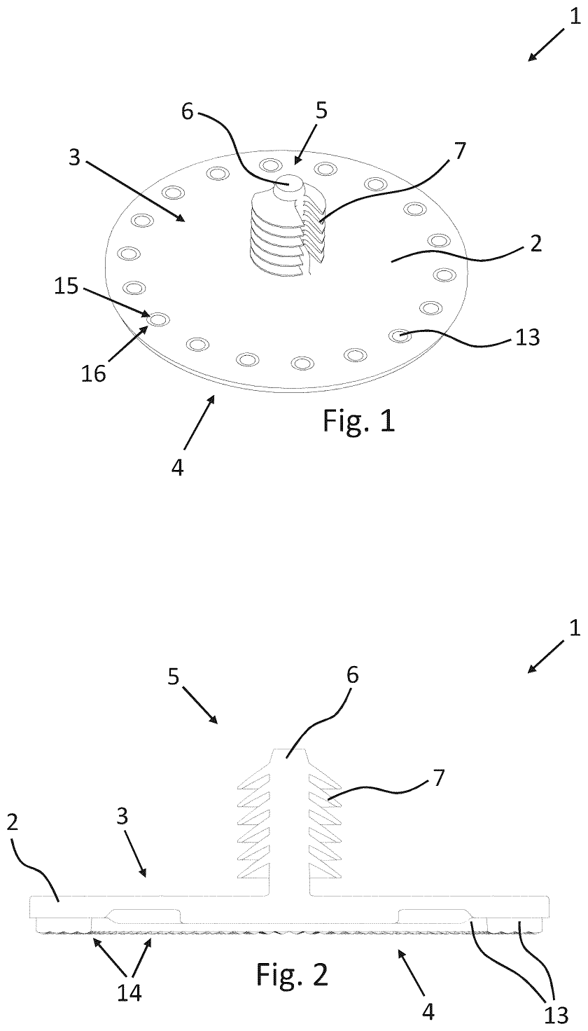

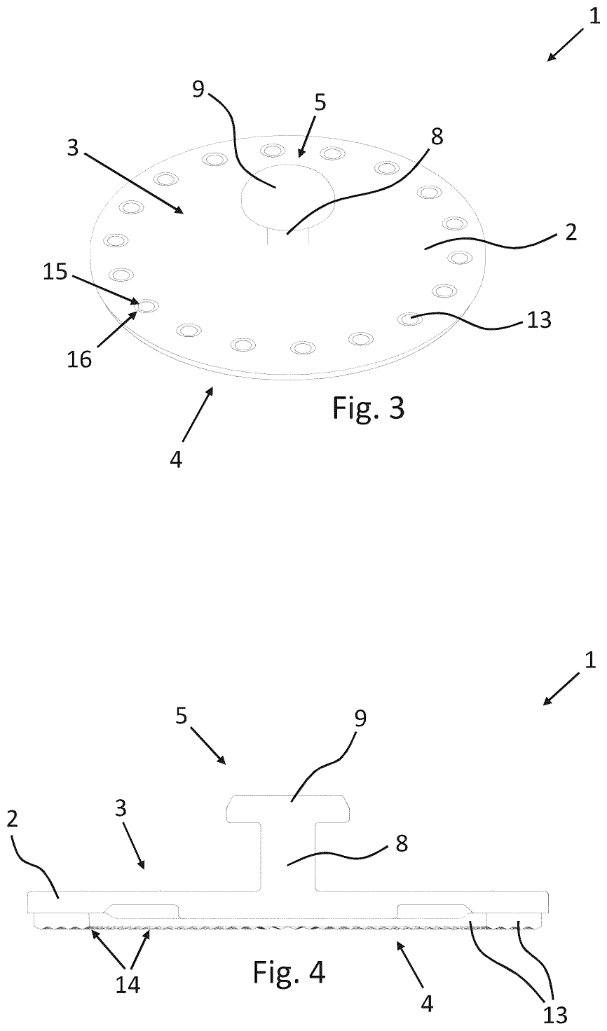

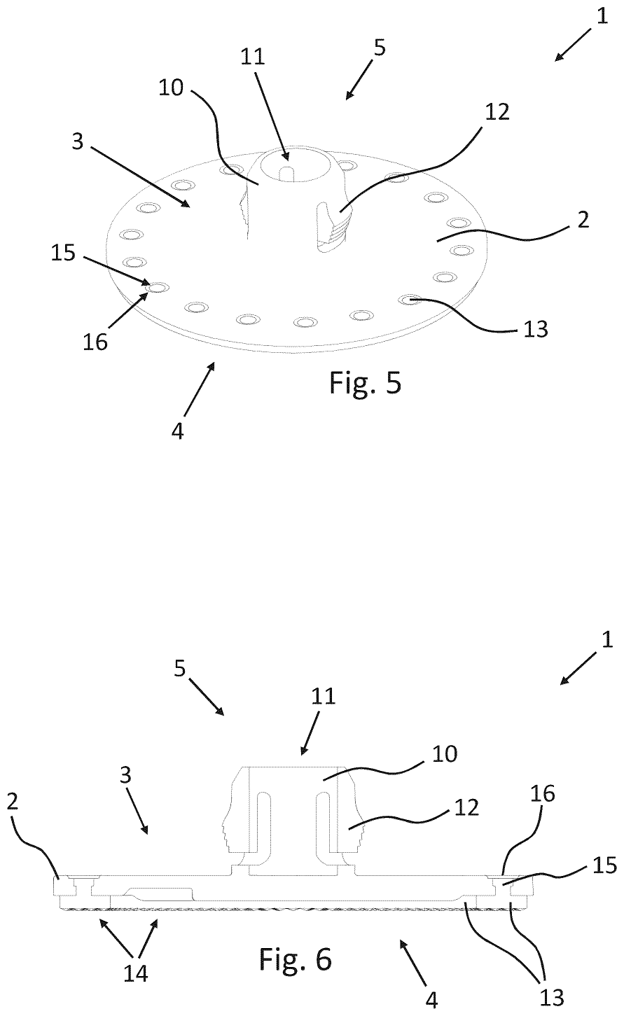

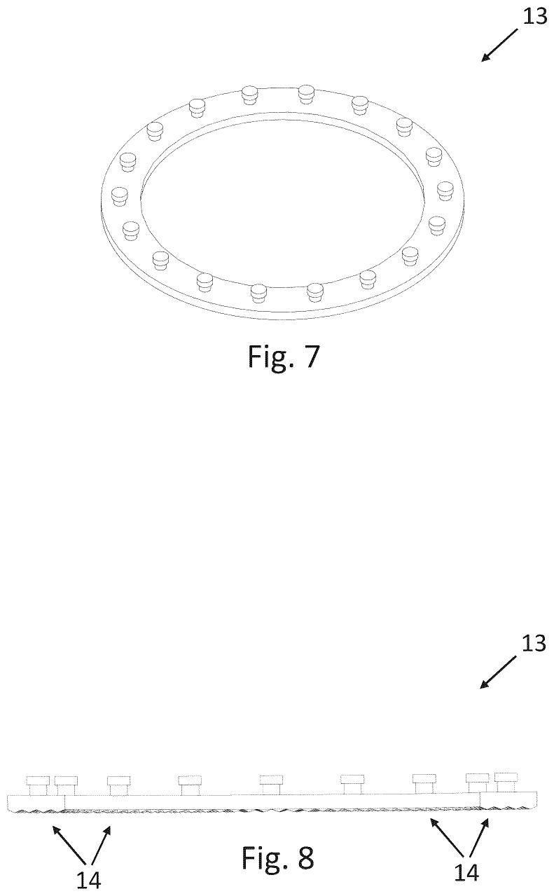

In the following, a fastening aid 1 for fastening components to a carrier component, in particular a body of a motor vehicle, is described in further detail (FIGS. 1 to 8). Specifically, FIG. 1 illustrates a perspective top view of a schematic representation of a fastening aid according to the disclosure, having a fastening element in the form of a bolt with wing elements, while FIG. 2 illustrates a side-cut schematic diagram of the fastening aid according to the disclosure, having the fastening element in the form of a bolt with wing elements. FIG. 3 illustrates a perspective top view of a schematic representation of the fastening aid according to the disclosure, having a fastening element in the form of a pin having a catching element molded thereon. FIG. 4 illustrates a side-cut schematic representation of the fastening aid according to the disclosure, having the fastening element in the form of a pin having a catching element molded thereon. FIG. 5 illustrates a perspective top view of a schematic representation of the fastening aid according to the disclosure, having a fastening element in the form of a bushing having the catching elements molded thereon. FIG. 6 illustrates a side-cut schematic representation of the fastening aid according to the disclosure, having the fastening element in the form of a bushing having catching elements molded thereon. FIG. 7 illustrates a perspective top view of a schematic representation of a soft component of the fastening aid according to the disclosure. FIG. 8 illustrates a side-cut schematic representation of the soft component of the fastening aid according to the disclosure.

The fastening aid 1 comprises a completely circular disc-shaped carrier body 2. The carrier body 2 is made from a hard component and comprises a fastening side 3 and an attachment side 4. The attachment side 4 is the side with which the fastening aid 1 is attached to the carrier component. The hard component is a stable plastic material.

In the center of the fastening side 3, a fastening element 5 is molded onto the carrier body 2. The carrier body 2 and the fastening element 5 are integrally formed such that they can be manufactured in an injection-molding process.

The fastening element 5 can be configured as desired. The fastening element 5 can be a bolt 6 having a plurality of movable wing elements 7 molded thereon, which are configured to act as barbed hooks for a counter-fastening element (FIGS. 1 and 2). It can also be provided that the fastening element 5 is a pin 8 with the catching element 9 molded thereon (FIGS. 3 and 4). The fastening element 5 can also be a bushing 10 having a blind boring 11 and catching elements 12 molded thereon (FIGS. 5 and 6).

The fastening side 3 (apart from the fastening element 5) and the attachment side 4 are configured to be smooth and circular in a top view.

A soft component 13 is arranged to fully cover the surface of the attachment side 4. The soft component 13 is made from an activatable adhesive material. If an activation energy is applied, the adhesive material exercises its adhesive effect and can be attached to a carrier body.

The soft component 13 has a structured surface 14 on the side facing away from the attachment side 4. Due to the texturing 14, the soft component 13 does not yet adhere so well to the carrier component prior to activation, as a result of which it can still be removed easily.

A plurality of through-holes 15 are provided in the carrier body 2. The through-holes 15 extend from the attachment side 4 to the fastening side 3 and are filled with the soft component 13. In addition, widenings 16 are provided on the fastening side 3, in which the soft component 13 is also arranged (FIGS. 7 and 8). If the soft component 13 is activated, then the soft component 13 generates an additional material-locking and positive-locking connection between the carrier body 2 and the soft component 13 in the through-holes 15 and in the widenings 16.

An apparatus for attaching a fastening aid 1 as discussed above to a carrier component, in particular a body of a motor vehicle, is described in further detail below (not shown).

The apparatus comprises a vertically arranged elongated and cylindrical reservoir and an activation device arranged adjacent thereto. The activation device is likewise elongated in shape and vertically arranged. In a vertically lower region, a horizontally extending traveling device is provided.

The reservoir, the activation device, and the traveling device are coupled to one another and form a unit. The unit is connected to a movement device (not shown) by means of which the unit can be moved in the space.

Furthermore, the reservoir is configured as a magazine for retaining a plurality of vertically arranged fastening aids 1. The fastening aids 1 each comprise a fastening side 3 having a fastening element 5 and an attachment side 4 having a soft component 13. The fastening aids 1 are retained with the attachment side 4 in the direction of the carrier component.

The reservoir comprises a traveling cylinder, with the help of which the fastening aids 1 can be moved into a frontmost position of the reservoir. The frontmost position is the position of the fastening aid 1 to be attached next in sequence by the apparatus. This position is located at the end of the reservoir that is the nearest to the carrier component in each case.

A first retaining apparatus is provided in order to fix the fastening aid 1 in this position and to supply the traveling device 23. For this purpose, the first retaining apparatus can release the fixed fastening aid 1 in the frontmost position, whereby the fastening aid 1 can be received by the traveling device.

The traveling device comprises a traveling unit with which a fixing unit can be moved horizontally between the frontmost position on the reservoir 21 and the activation device. With the fixing unit, the fastening aid 1 can be received and fixed on the reservoir by the first retaining apparatus.

Accordingly, the activation apparatus comprises a second retaining apparatus with which the fastening aid 1 can be received by the activation apparatus. The fixing unit can also be configured to form the second retaining apparatus.

The movable unit is configured to move the activation device towards the carrier component so that the fastening aid 1 can be arranged on the carrier component with the soft component 13 in first place by means of the activation device.

In the present exemplary embodiment, the activation device is configured as an ultrasonic welding device. At an end facing the carrier component, the activation device comprises a sonotrode with which ultrasonic waves can be transmitted.

If a fastening aid 1 is attached to the carrier component by means of ultrasonic waves, then the unit consisting of reservoir, activation device, and traveling device can be moved to a next location where a fastening aid 1 is to be arranged.

The sonotrode can have the following features: cycle time <1 s (0.2 s welding), pressure of the sonotrode: ±200N, temperature generated on the hot-melt adhesive: 110 to 140° C., ambient temperature within which the sonotrode is preferably operated: −30° C. to 50° C., max. ambient temperature within which the sonotrode is operable: −40° C. or 80° C.

Furthermore, a method for attaching a fastening aid 1 as discussed above to a carrier component, in particular a body of a motor vehicle, will be described in further detail, having an apparatus for attaching such a fastening aid 1 as described above.

A unit consisting of a reservoir, an activation device, and a traveling device 23 is in a neutral position above the carrier component. The term “unit” means that the reservoir, activation device, and traveling device are coupled to one another and are movable together.

A plurality of vertically arranged fastening aids 1 are retained in the elongated, cylindrical reservoir. The fastening aids 1 each comprise a fastening side 3 having a fastening element 5 and an attachment side 4 having a soft component 13. The fastening aids 1 are retained with the attachment side 4 in the direction of the carrier component.

By means of a traveling cylinder, the fastening aids 1 are moved progressively towards a frontmost position of the reservoir. The frontmost position is the position of the fastening aid 1 to be attached next in sequence by the apparatus. This position is located at the end of the reservoir that is the nearest to the carrier component in each case.

At the frontmost position, the fastening aid 1 of the traveling device is provided.

By means of the traveling device, the fastening aid 1 is received and conveyed horizontally to the activation device.

The activation device receives the fastening aid 1 and places the fastening aid 1 at a location on the carrier component to be attached such that the soft component 13 is in contact with the carrier component. The arrangement of the fastening device is accomplished by way of a substantially vertical movement of the activation device towards the carrier component. By means of the activation device, a slight clamping pressure can be exerted on the fastening aid 1.

By means of a sonotrode of the activation device, ultrasonic waves are generated after the arrangement. The soft component 13 is exposed to the ultrasonic waves and thus activated. By way of the activation, the soft component 13 is melted and connects to the carrier component.

After attaching the fastening aid 1 to the carrier component, the activation device is transferred back to the neutral position. From this position, the attachment of the next fastening aid 1 can begin, in that the unit consisting of the reservoir, the activation device, and the traveling device is moved together to the next location where a fastening aid is to be arranged on the carrier component.

After attachment of a fastening aid 1, a quality control can be provided by an optical inspection or by a tensile test (by applying a tensile force onto the fastening aid 1).

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### LIST OF REFERENCE NUMERALS

1 Fastening aid
2 Carrier body
3 Fastening side
4 Attachment side
5 Fastening element
6 Bolt
7 Wing element
8 Pin
9 Catching element
10 Bushing
11 Blind boring
12 Catching element
13 Soft component
14 Texturing
15 Through-hole
16 Broadening

What is claimed is:

1. A fastening aid (1) for fastening components to a carrier component, in particular a body of a motor vehicle, comprising
a plate-shaped carrier body (2) made from a hard component having a fastening side (3) and attachment side (4), wherein the attachment side (4) is the side with which the fastening aid (1) is attached to the carrier component, and
a soft component (13) provided on the attachment side (4), wherein the soft component (13) is made from an adhesive material that can be activated through the carrier body (2),
wherein a fastening element (5) is arranged on the fastening side (3) and can be connected to a counter-fastening element of a component.

2. The fastening aid (1) according to claim 1, wherein
the soft component (13) can be activated by one or more of the following activation methods:
preferably by means of ultrasonography,
by means of electromagnetic radiation, in particular infrared light, wherein the carrier body (2) is configured to be permeable to the electromagnetic radiation and the soft component (13) is configured to be impermeable to the electromagnetic radiation,
by means of hot air,
by means of induction, wherein the carrier body (2) is configured such that a current that heats the carrier body (2) can be induced, and/or wherein a current that heats the carrier component in a region of the fastening aid (1) is induced, or
by means of physical pressure.

3. The fastening aid (1) according to claim 1, wherein the fastening element (5) is configured as one of the following elements:
a pin with or without a catching element (12) molded thereon,
a bushing (10) having a blind boring (11), with or without an internal threading, with or without at least one catching element (12) molded thereon,
a bolt (6) having at least one movable wing element (7) molded thereon, which is configured to act as a barbed hook for a counter-fastening element,
a bolt (6) with or without an external threading,
a hook,
an eyelet,
a catching lug,
an undercut, or
the fastening element (5) is configured to form a bayonet closure together with a corresponding counter-fastening element.

4. The fastening aid (1) according to claim 1, wherein the fastening element (5), in a top plan view of the fastening side (3), is limited to a central region of the fastening side (3), so that the fastening aid (1) on the fastening side (3) can be contacted with an activation device (22) circumferentially at an edge region of the fastening side (3).

5. The fastening aid (1) according to claim 1, wherein the fastening aid (1) has a shape that is complementary to a surface of the carrier component.

6. The fastening aid (1) according to claim 1, wherein the carrier body (2) comprises a texturing (14) on the attachment side (4), wherein regions are provided at which no soft component (13) is arranged.

7. The fastening aid (1) according to claim 6, wherein the soft component (13) comprises a texturing (14) on the attachment side (4), where-in discharge channels are configured in the texturing (14) which extend at least in sections approximately outwardly towards the edge of the carrier body (2).

8. The fastening aid (1) according to claim 6, wherein through-holes (15) are provided in the carrier body (2), which extend from the attachment side (4) to the fastening side (3) and in which the soft component (13) is arranged, in order to establish a material-locking connection between the carrier body (2) and the soft component (13) when the soft component (13) is cured, wherein the through-holes (15) preferably each comprise a contour, in particular widenings on the fastening side (3), in which the soft component (13) is arranged in order to establish a positive-locking connection between the carrier body (2) and the soft component (13) when the soft component (13) is cured.

9. An apparatus for attaching a fastening aid (1) according to claim 4 to a carrier component, in particular a body of a motor vehicle, comprising
a reservoir for retaining fastening aids (1), in particular different types of fastening aids (1), having a soft component (13),
a traveling device in order to supply one of the fastening aids (1) from the reservoir to the activation device, and
the activation device for arranging the fastening aid (1) at a location on the carrier component to be attached and for generating ultrasonic waves, electromagnetic waves, hot air, induction voltage, or physical pressure in order to activate the soft component (13) and attach the fastening aid (1).

10. A method for attaching a fastening aid (1) according to claim 1 to a carrier component, in particular a body of a motor vehicle, having an apparatus for attaching such a fastening aid (1), according to claim 9, comprising
retaining of fastening aids (1) in a reservoir,
providing one of the fastening aids (1) from the reservoir for a traveling device,
supplying the fastening aid (1) to an activation device by means of the traveling device,
arranging the fastening aid (1) by means of the activation device at a location on the carrier component to be attached, and
attaching the fastening aid (1) at the location to be attached by way of an activation of a soft component (13) of the fastening aid (1) by means of the activation device.
